(19) United States
(12) Patent Application Publication
(10) Pub. No.: US 2010/0097473 A1
(43) Pub. Date: Apr. 22, 2010

(54) DEVICE FOR CONNECTING VIDEO CAMERAS TO NETWORKS AND CLIENTS

(75) Inventors: Youngchoon Park, Brookfield, WI (US); Osama Lotfallah, Greendale, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/581,802

(22) Filed: Oct. 19, 2009

Related U.S. Application Data
(60) Provisional application No. 61/106,882, filed on Oct. 20, 2008.

(51) Int. Cl. H04N 7/18; H04N 7/26; H04N 5/232

(52) U.S. Cl. 348/159; 386/124; 348/211.3; 348/E07.085; 348/E05.042

(57) ABSTRACT

A device for recording digital video from a plurality of cameras connected to the device includes a communication interface configured to receive compressed digital video from each of the plurality of cameras. The device further includes processing electronics including a digital video recorder module configured to store the compressed digital video. The processing electronics are further configured to identify a parameter indicative of complexity of the compressed digital video from each of the plurality of cameras. The processing electronics are yet further configured to adjust at least one of a camera parameter and a parameter of the digital video recorder module based on the parameter indicative of the complexity of the compressed digital video.

### CROSS-REFERENCE TO RELATED APPLICATIONS

This application claims the benefit of U.S. Provisional Application No. 61/106,882, filed Oct. 20, 2008, which is incorporated by reference in its entirety.

### BACKGROUND

The present invention generally relates to systems, devices, and methods for connecting video cameras to networks and clients.

Multiple video cameras are often used in applications such building surveillance or monitoring. Digital video cameras are often connected to conventional IT networking components (e.g., hubs, routers, switches, etc.) that form a part of a larger IT network. A server for recording the video is then connected to the digital video cameras via the larger IT network. Clients connect to the server for downloading or playing back the video. As IT network conditions and setups can be of varying reliability or capability, conventional video camera systems are often configured to provide video that is highly compressed or highly buffered in an effort to ensure that IT network, server recording, and client problems are reduced. It is challenging and difficult to design and implement high performance video systems that utilize multiple cameras.

### SUMMARY

One embodiment of the invention relates to a device for providing digital video to a remote client from one of a plurality of cameras connected to the device. The device includes a housing, a first set of communication interfaces, a second set of communication interfaces, and processing electronics integrated with the housing. The first set of communication interfaces is configured to communicate with the plurality of video cameras. The second set of communication interfaces is configured to communicate with a remote client for receiving the digital video. The processing electronics are configured to respond to a uniform resource identifier (URI) request received at the second set of communication interfaces from the remote client and to deliver the digital video to the remote client by parsing the URI request for a camera identifier and establishing a port forwarding connection between the remote client and at least one of: (a) a camera corresponding to the camera identifier, (b) a logical port created in memory of the device, and (c) an interface of the first set of communication interfaces.

Another embodiment of the invention relates to a device for recording digital video from a plurality of cameras connected to the device. The device includes a communication interface configured to receive compressed digital video from each of the plurality of cameras. The device further includes processing electronics including a digital video recorder module configured to store the compressed digital video. The processing electronics are further configured to identify a parameter indicative of complexity of the compressed digital video from each of the plurality of cameras. The processing electronics are yet further configured to adjust at least one of a camera parameter and a parameter of the digital video recorder module based on the parameter indicative of the complexity of the compressed digital video.

Another embodiment of the invention relates to a camera configured to provide compressed video over a network. The camera includes a processing circuit configured to determine available network resources for transmitting the compressed video. The processing circuit is further configured to adjust at least one of a frames per second setting for the camera and a compression parameter for the compressed video based on the determined available network resources. The camera may receive information describing the available network resources from a remote source or base the determination of available network resources on information from a remote source. The processing circuit may be configured to adjust the at least one of the frames per second setting for the camera and the compression parameter for the compressed video based on the determination of whether the p-frame size and/or b-frame size for the compressed video has significantly changed. The processing circuit may be configured to determine that the p-frame size and/or b-frame size have significantly changed when the p-frame size and/or b-frame size are above or below three standard deviations of the median size.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a video camera in an environment coupled to a networked device, according to an exemplary embodiment;

FIG. 2 is a block diagram of a system for use with the networked device of FIG. 1, according to an exemplary embodiment;

FIG. 3A is a detailed block diagram of the networked device of FIGS. 1-2, according to an exemplary embodiment;

FIG. 3B is a flow chart of a process for configuring the networked device of FIGS. 1-2 and connected cameras, according to an exemplary embodiment;

FIG. 3C is a simplified block diagram of a networked device configured to respond to requests for video using a web service and processing electronics configured to provide port forwarding between a remote client and one of a plurality of connected video cameras, according to an exemplary embodiment;

FIG. 3D is a flow chart of a process for providing video to a remote client (using, e.g., the system and device of FIG. 3C), according to an exemplary embodiment;

FIG. 4A is a flow chart of a process for adjusting a parameter of the digital video recorder or a camera connected thereto based on analysis of the compressed video, according to an exemplary embodiment;

FIG. 4B is a more detailed flow chart of a process for adjusting a parameter of the digital video recorder or a camera connected thereto based on analysis of the compressed video, according to an exemplary embodiment;

FIG. 4C is a detailed flow chart showing a possible continuation of the process shown in FIG. 4B, according to an exemplary embodiment;

FIG. 5 is a detailed view of the housing of the networked device of FIGS. 1-2, according to an exemplary embodiment;

FIGS. 6A-B is a view of linking networked devices, according to an exemplary embodiment;

FIG. 7A is a block diagram of a camera configured to provide compressed video over a network and to adjust itself using, for example, the processes of FIGS. 4B and 4C, according to an exemplary embodiment; and

FIG. 7B is a flow chart of a process for providing compressed video over a network from a camera such as the camera of FIG. 7A, according to an exemplary embodiment.

### DETAILED DESCRIPTION

Referring generally to the figures, a device is shown that integrates: (a) network communications electronics for connecting to and communicating with a plurality of cameras; and (b) video processing electronics for controllably providing video from the cameras to networks and clients. The video processing electronics advantageously adapt settings of the device or the cameras based on “live” video, camera, network, or client conditions. For example, the network communications electronics can be configured to provide network setup and traffic management features particular to video cameras and video data. Devices of the present disclosure are intended to ease physical setup, configuration, ongoing use, and maintenance of a plurality of video cameras in a building.

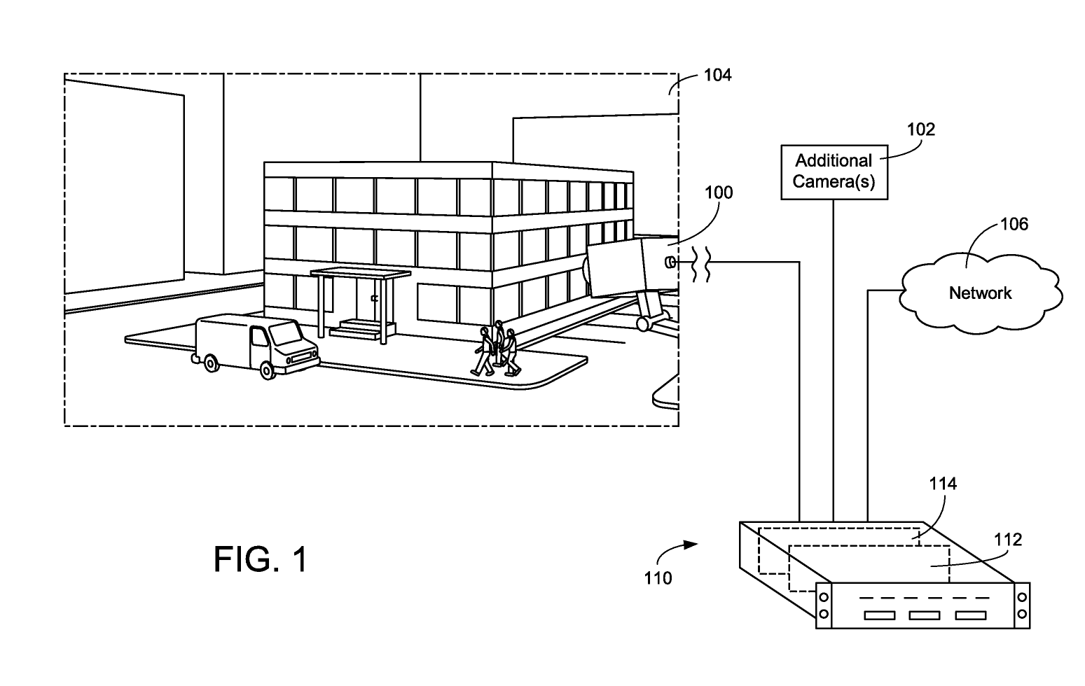

Referring to FIG. 1, a perspective view of a video camera 100 in an environment 104 coupled to a networked device 110 is shown, according to an exemplary embodiment. Video camera 100 may be used for surveillance and security purposes, entertainment purposes, scientific purposes, or for any other purpose. Video camera 100 may be an analog or digital camera and may contain varying levels of video storage and video processing capabilities. According to an exemplary embodiment, video camera 100 may be a networked video camera such as a MPEG4-Compatible Network Security Camera, model number WV-NP244, sold by Panasonic. Video camera 100 is shown communicably coupled to networked device 110. Networked device 110 is shown to include a video module 114 and a network communications module 112. Networked device 110 is communicably coupled to one or more video cameras 102 in addition to video camera 100.

Networked device 110 is configured to provide network setup and traffic management for video cameras 100-102. Networked device 110 is also configured to facilitate the configuration of the video cameras, store video data received from the video cameras, or process the video data received from video cameras 100-102. The communication connection between video cameras 100-102 and networked device 110 may be wired, wireless, analog, digital, IP-based, or use any other suitable communications systems, methods, or protocols. In an exemplary embodiment the communication connections between video cameras 100-102 and networked device 110 are direct wired connections and video cameras 100-102 are digital IP cameras that provide compressed video (e.g., MPEG-4 video) to networked device 110. Video cameras 100-102 may be installed in or capture in any environment. The environment may be an indoor area and/or an outdoor area, and may include any number of persons, buildings, cars, spaces, zones, rooms, and/or any other object or area that may be either stationary or mobile. Video cameras 100-102 may be stationary (e.g., fixed position, fixed angle), movable (e.g., pan, tilt, zoom, etc.), or otherwise configured.

Referring still to FIG. 1, networked device 110 is connected via an uplink connection to a network 106 that may include additional video cameras, client devices, server devices, video processing systems, printers, scanners, building automation systems, a surveillance management system, a security system, and/or any other type of system, network, or device. Networked device 110 can advantageously isolate the video camera branch from network 106. So, for example, the high bandwidth video content will be sent from video cameras 100-102 to networked device 110 on a regular basis, but not transmitted to the entirety of network 106 (unless requested or otherwise caused to be relayed to network 106).

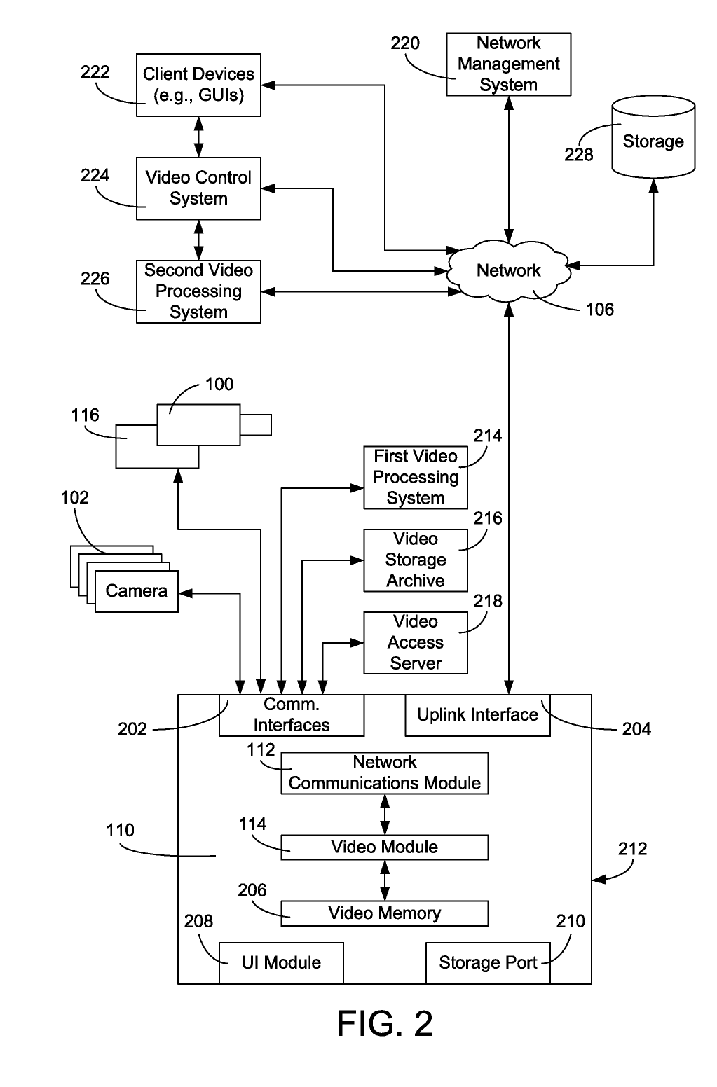

Referring to FIG. 2, a block diagram of another system for use with the networked device of FIG. 1 is shown, according to an exemplary embodiment. In FIG. 2, networked device 110 is coupled to a plurality of video cameras 100-102 via communication interfaces 202 (e.g., terminals, ports, plug-ins, jacks, IEEE 802.3 compatible interfaces, interfaces compatible with BNC connectors, interfaces compatible with RJ45 connectors, etc.). Video cameras 100-102 may include different levels of video processing capabilities ranging from having zero embedded processing capabilities (i.e., a camera that provides an unprocessed input to networked device 110) to having a significant camera processing component (e.g., for detecting objects within the video, for creating meta data descriptions of the video, etc.) such as processing component 116 of camera 100. Video cameras 100-102 may include varying degrees or types of video compression electronics or software configured to provide digital video to networked device 110 in one or more formats (e.g., raw video, MPEG-4 compressed video, etc.).

Networked device 110 is coupled to network 106 via an uplink interface 204. Uplink interface 204 may be the same or different from the communication interfaces to which the plurality of cameras 102 are attached (e.g., an RJ45 compatible female jack, a fiber optic jack, etc.). The connection between networked device 110 and network 106 may be via a direct wired connection, a wireless connection, one or more LANs, WANs, VLANs, or via any other connection method. Network 106, as shown, may include or be communicably coupled to various systems and devices 220-228 (e.g., a network management system 220, client devices 222, a video control system 224, a second video processing system 226, networked storage 228, etc.). Some of client devices 222 may be configured to display graphic user interfaces (GUIs) for interacting with networked device 110, for interacting with cameras 102, or for viewing video data received from cameras 102. Further, some of client devices 222 may be configured to receive alarms or other meta information relating to the video data (e.g. an alarm providing an indication that unauthorized movement has been detected by a camera, an object description of an object detected in the video, a tag relating to the content of the video, etc.). One or more network storage devices (e.g., memory, databases, storage 228, etc.) may also be connected to network 106 and used to store data from networked device 110 or from a camera.

Networked device 110 is shown to include a network communications module 112, video module 114, and video memory 206. According to an exemplary embodiment, network communications module 112 is configured to provide network setup and traffic management for a plurality of connected devices. Network communications module 112 can also provide network setup and traffic management for itself (e.g., relative to the plurality of cameras, relative to the uplink connection or an upstream network, relative to clients, etc.). Video module 114 can be configured to facilitate the configuration of video cameras connected to networked device 110. Video module 114 may also (or alternatively) be configured to store video data from the video cameras or to process data and video received from the video cameras. Video data may be stored in video memory 206.

According to an exemplary embodiment, network communications module 112 includes switching circuitry such that networked device 110 can operate as a network switch (e.g., a computer networking device that connects network segments, a device that routes and manages network traffic among/between a plurality of connected devices, etc.). According to an exemplary embodiment, network communications module 112 operates to create a different collision domain per switch port—allowing for point-to-point connections between a camera and other devices connected to the networked device that have dedicated bandwidth (e.g., able to operate in full duplex mode, able to operate without collisions with communications from other connections).

As further shown in FIG. 2, other systems and devices such as a video processing system 214, a video storage archive 216, and/or a video access server 218 may be connected to networked device 110 via communication interfaces 202 such that the traffic among and between such systems and devices and video cameras 102 does not burden other parts of the network.

Video processing system 214 may be configured to process data received by one or more of the cameras (e.g., to conduct object tracking activities, object extraction activities, compression activities, transcoding activities, etc.). Video storage archive 216 may be a server computer or an array of memory devices (e.g., optical drives, hard drives, etc.) configured to store and/or catalog video data for long term storage. Video access server 218 may be a server computer configured to host web services, a web server, and/or any other server module for providing access to the video data of the system to any local or remote clients. For example, video access server 218 may provide a service to second video processing system 226, remote video control system 224, and/or client devices 222 configured to display graphical user interfaces (GUIs).

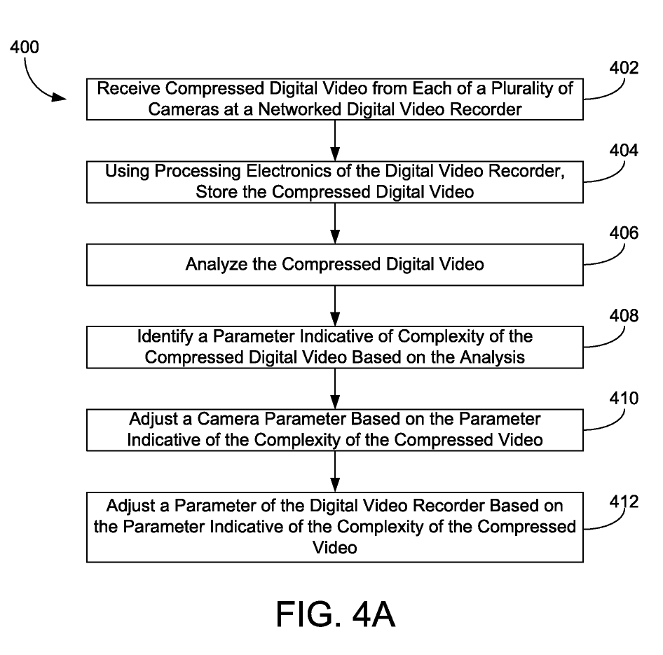

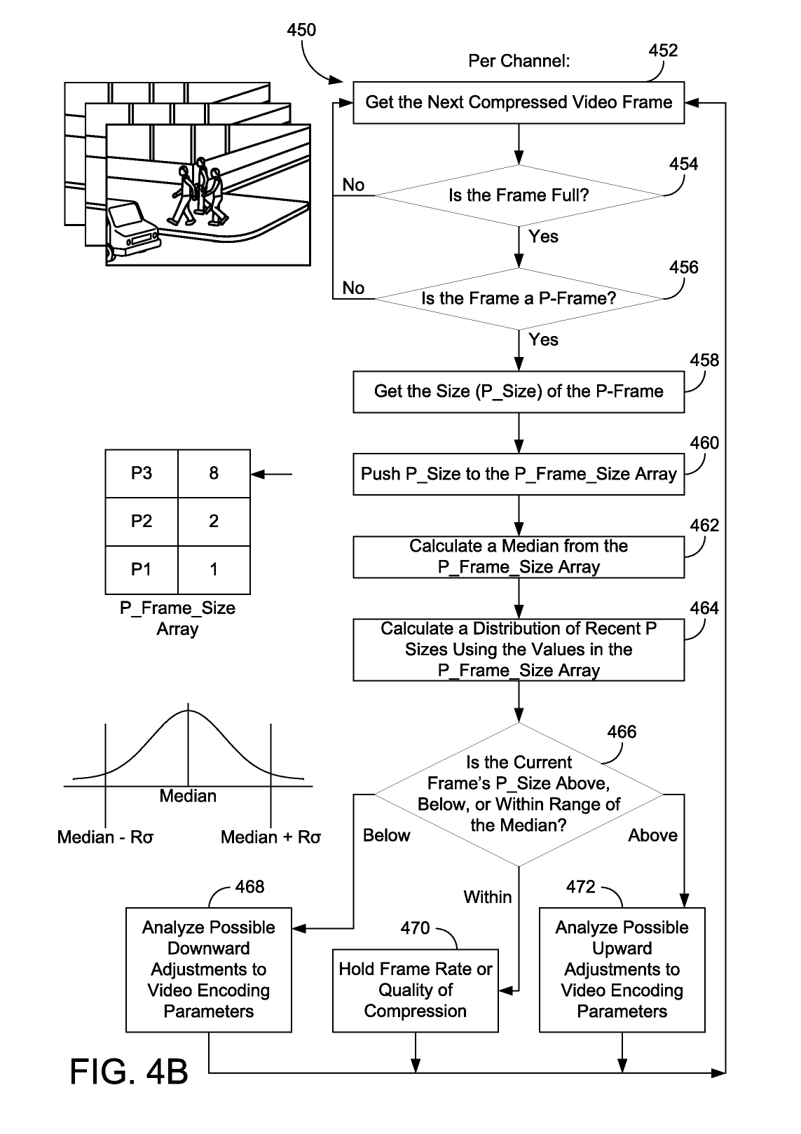

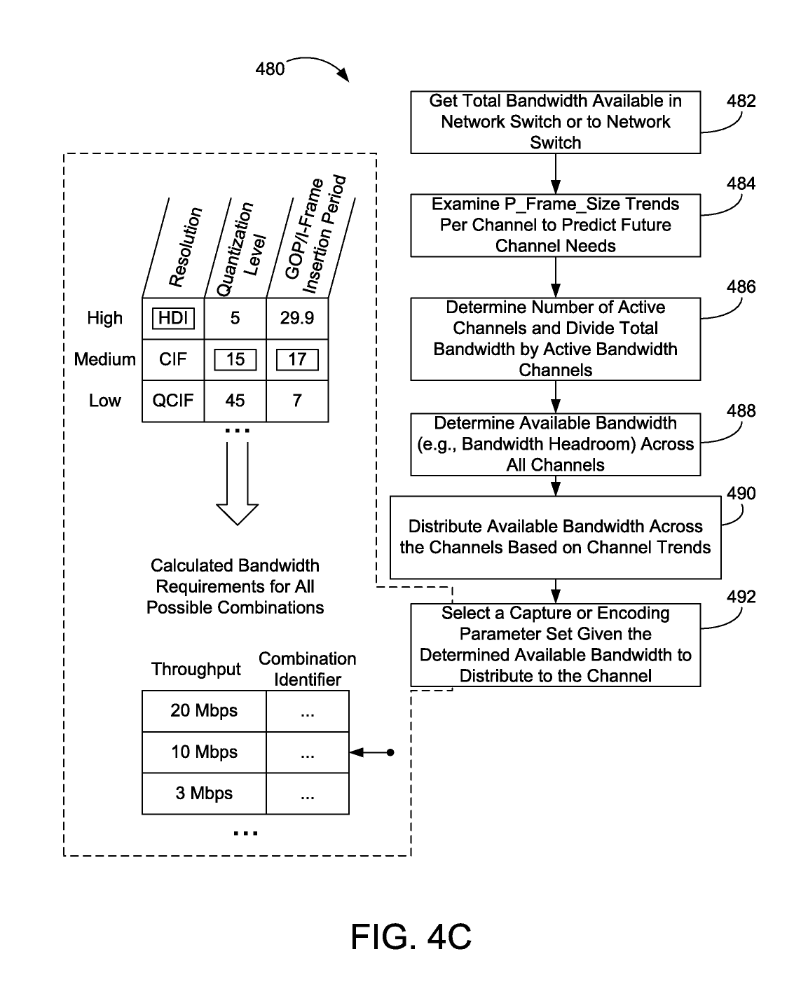

Referring still to FIG. 2, networked device 110 is further shown to include a user interface (UI) module 208 and a storage port 210. UI module 208 may include an electronic display (e.g., LCD display, OLED display, etc.), buttons, or any other user interface elements. Storage port 210 may be, for example, an iSCSI port or other type of port or connector for connecting networked device 110 to external storage devices. Networked device 110 further includes a device housing 212 for housing the components of networked device 110. Device housing 212 is described in greater detail in FIG. 4. UI module 208 may be embedded on or within housing 212 and configured such that networked device 110 may be configured directly via UI module 208.

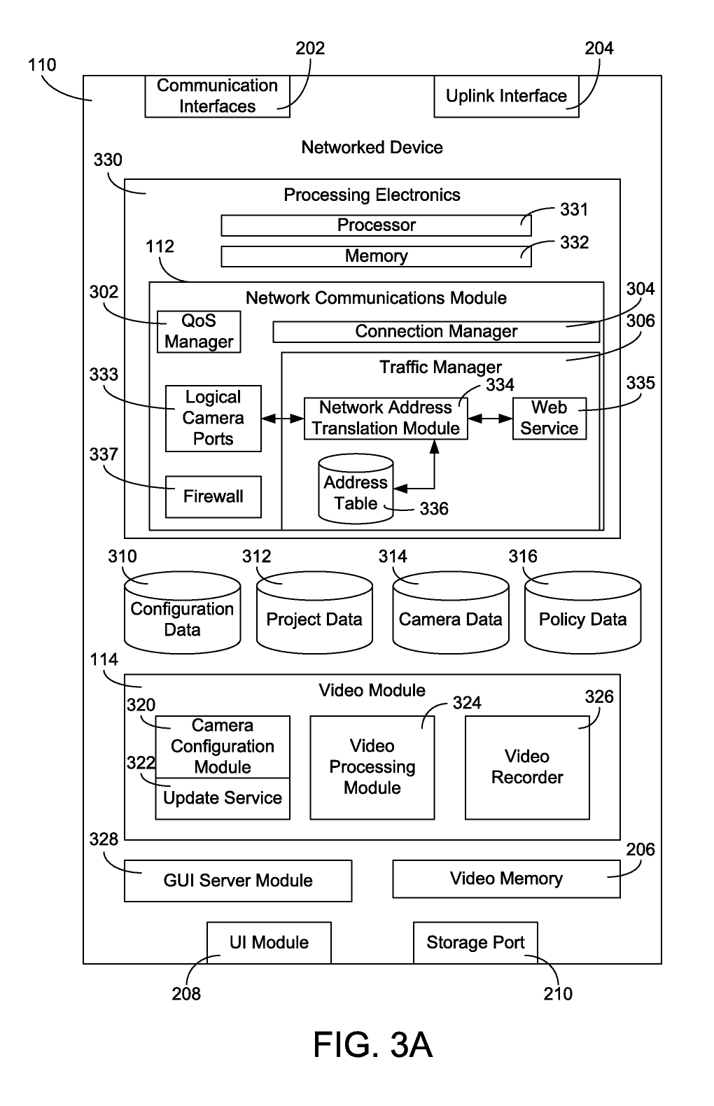

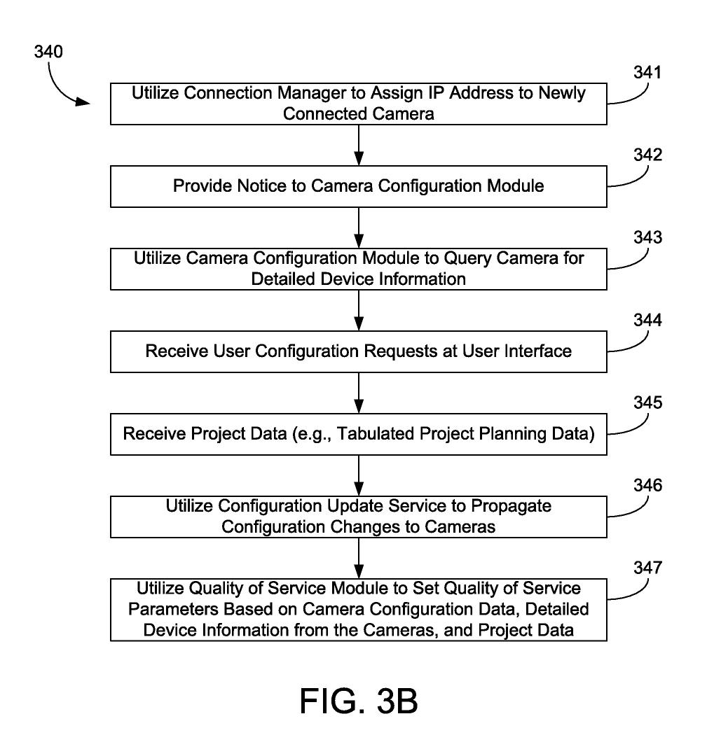

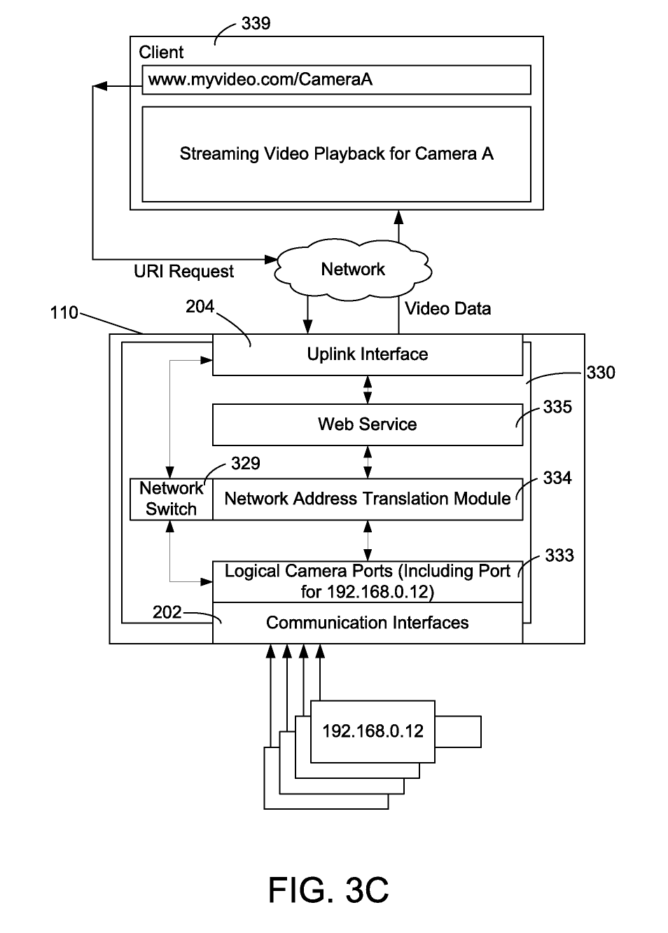

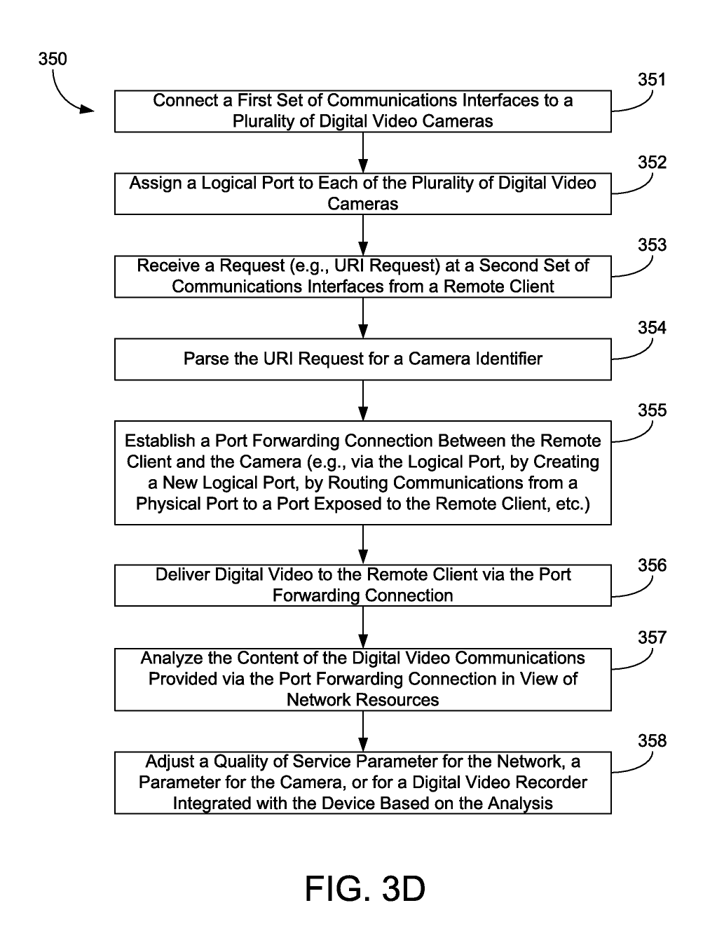

Referring now to FIG. 3A, a detailed block diagram of networked device 110 shown in FIGS. 1-2 is shown, according to an exemplary embodiment. Networked device 110 is shown to include video module 114, video memory 206, a GUI server module 328, and processing electronics 330 including network communications module 112.

Network communications module 112 of processing electronics 330 is shown to include a connection manager 304. Connection manager 304 may be a hardware module (e.g., an application specific integrated circuit), a computer code module, an executable software module, or a combination of hardware and software. Connection manager 304 may configure or facilitate the configuration of devices connected to communication interfaces 202 of networked device 110. Connection manager 304 may include a dynamic host configuration protocol (DHCP) server element configured to allow network devices (e.g., digital cameras) coupled to communication interfaces 202 to obtain parameters for networked communications (e.g., obtain parameters for internet protocol (IP) communications, obtain private IP addresses, etc.). According to an exemplary embodiment, the DHCP server may be turned on and/or off by user command received at a user interface, by signals received via uplink interface 204, by signals received via communication interfaces 202, or by any other mechanism. For example, when IP addresses are managed by a DHCP server remote from networked device 110 (e.g., a corporate level DHCP server, an enterprise level DHCP server, the network management system shown in FIG. 2, etc.), it may be desirable to turn off the networked device's DHCP serving feature.

Network communications module 112 is further shown to include a traffic manager 306. Traffic manager 306 may be configured to operate as a switch (e.g., network switch, packet switch), as a hub, and/or as a router. The behavior of traffic manager 306 may be user configurable (e.g., via a user interface generated for the user on a local electronic display or on a connected terminal). According to an exemplary embodiment, traffic manager 306 is configured to operate with communication interfaces 202 to create a different collision domain per switch port (e.g., per communication interface). That is, the various cameras connected to communication interfaces 202 will not interfere with each other's transmissions (e.g., cause data collisions to occur). According to an exemplary embodiment, traffic manager 306 may be configured to provide switching activity to support network communications according to standards such as 10BASE-T, 100BASE-T, and 1000BASE-T.

According to an exemplary embodiment, connection manager 304 provides the IP address for a newly connected camera to camera configuration module 320. Camera configuration module 320 (e.g., a plug-and-play discovery service) may then query the newly connected camera for camera parameters (e.g., manufacturer, default resolution, encoding mechanism, etc.). According to an exemplary embodiment, networked device 110 may include a default set of camera data which may then be updated when specific camera parameters are received from the cameras.

As shown in FIG. 3A, one or more databases (e.g., configuration data 310, project data 312, camera data 314, policy data 316) may be used to store configuration information for networked device 110. When an installer is planning the video camera system with which networked device 110 will be used, the installer can use a local user interface, a remote user interface, or another device to provide project data to networked device 110. Project data 312 may relate, for example, a camera location to a frames-per-second parameter for the camera, an in-motion frames-per-second parameter, a recording duration for the camera, and the like. Networked device 110 can also be configured to store policy data 316, which may store information such as user names, access rights, storage duration for video of the machine, recording duration, the quality level of stored video, the encoding method of stored video, and the like. Configuration data 310 may include data regarding camera configurations, and camera data 314 may include data regarding the type of camera, camera specifications, etc.

Camera configuration module 320 may store configuration data and may also provide camera information received by querying the camera(s) to a quality of service (QoS) manager 302. QoS manager 302 can utilize configuration data 310, project data 312, camera data 314, and policy data 316 to update camera configuration data and/or to update QoS parameters (e.g., stored in QoS manager 302, stored in configuration data 310, etc.). According to an exemplary embodiment, QoS manager 302 can utilize linear optimization, multivariable optimization, matrix-based optimization, one or more weighted functions, or any other method for determining the QoS parameters of the system. According to an exemplary embodiment, QoS manager 302 automatically senses the bandwidth (and other parameters) available to networked device 110 at uplink interface 204. Using this information, QoS manager 302 can determine the QoS parameters for the system. According to an exemplary embodiment, QoS manager 302 can dynamically adjust the QoS parameters as conditions at uplink interface 204 change. QoS manager 302 and camera configuration module 320 may work together to optimize network and camera parameters. For example, if an IP camera includes an adjustable packet size parameter QoS manager 302 and camera configuration module 320 may synchronize the packet size parameter for the camera with a packet size parameter used by switching circuitry, network communications module 112, and/or traffic manager 306 of networked device 110.

According to an exemplary embodiment, connection manager 304 is configured to provide batch updating of connected devices. The batch updating may occur by connection manager 304 providing users with templates, graphical user interfaces, tables, or any other interface for providing configuration controls or fields for entering data. According to an exemplary embodiment, upon discovery of IP cameras, connection manager 304 automatically populates a configuration template for the cameras and configures the cameras and networked device 110 for communications. If a configuration template (e.g., table, grid, other data structure) is partially populated by connection manager 304 upon connecting a camera to networked device 110, camera configuration module 320 can be configured to further (e.g., complete) the population of the configuration template based on properties specific to the connected camera (e.g., the geolocation of the camera, the camera type, the angle of the camera, the lighting of the camera, etc.). Connection manager 304 and camera configuration module 320 can be configured to work together to maintain an updated set of configuration parameters for the connected cameras. The updating provided by connection manager 304 and/or camera configuration module 320 may be configured to occur on an automated basis, on an on-demand basis (e.g., user-requested, machine-requested, camera-requested, etc.), or on any other basis.

In addition to camera configuration module 320, video module 114 is shown to include a video processing module 324 and a video recorder 326. Video processing module 324 can be configured to conduct processing tasks on one or more of the video streams or sets of video data provided to networked device 110 by the connected cameras. For example, video processing module 324 can be configured to normalize the video received from the cameras, to compress the video received from the cameras, to extract meta data from the video, to create meta data for the video, to synchronize the video, etc.

Video recorder 326 can be configured to record the video received from the connected cameras in video memory 206. In addition to facilitating the saving of the video data in video memory 206, video recorder 326 can be configured to conduct any number of processing activities and/or cataloging activities relating to the video data. For example, video recorder 326 may work with object detection logic of video processing module 324 to characterize behavior stored or associated with video data in video memory 206. According to an exemplary embodiment, video recorder 326 is configured to describe objects and/or properties of the video using a mark-up language such as an extensible markup language (XML) or another structured language.

Video module 114 may include other modules or may conduct additional or alternative activities relative to those conducted by camera configuration module 320, video processing module 324, and video recorder 326. According to an exemplary embodiment, video module 114 is configured to conduct at least one activity specific to the video data received from the cameras (e.g., recording the video, compressing the video, describing the video, segmenting the video, encrypting the video, encoding the video, decoding the video, etc.).

GUI server module 328 of networked device 110 may be configured to provide graphical user interface (GUI) services to one or more connected terminals, computers, or user interfaces. For example, GUI server module 328 may be configured as a web host configured to allow remote access to the configuration GUIs of networked device 110. GUI server module 328 may be configured to allow an administrator to populate spreadsheet-like tables or other user interface elements (e.g., pop-up windows, dialog boxes, forms, checklists, etc.) for configuring the cameras, for adjusting the settings or activities of network communications module 112, or for adjusting the settings or activities of video module 114. As updates are received by the system, an update service 322 associated with camera configuration module 320 can be configured to update configuration data 310 of the system, cause the updating of QoS parameters, update policy data 316, and cause the updates to be pushed to the cameras and/or to other modules of the system that may change their behavior based on updated configuration data (e.g., video recorder 326).

Video memory 206 can be one or more memory devices or units of one or more types or configurations for storing video data. For example, video memory 206 may be solid state random access memory, flash memory, hard drive based memory, optical memory, or any combination thereof. According to an exemplary embodiment, video memory 206 includes a relatively small amount of high speed random access memory or cache for temporarily storing the video data (e.g., prior to long-term storage, during processing, etc.) in addition to a large amount of memory for longer-term storage (e.g., non-volatile memory, a hard disk, a hard disk array, a RAID array, etc.).

Processing electronics 330 is shown to include a processor 331 and memory 332. Processor 331 may be a general purpose or specific purpose processor configured to execute computer code or instructions stored in memory 332 or received from other computer readable media (e.g., CDROM, network storage, a remove server, etc.). Memory 332 may be RAM, hard drive storage, temporary storage, non-volatile memory, flash memory, optical memory, or any other suitable memory for storing software objects and/or computer instructions. When processor 331 executes instructions stored in memory 332 for completing the various activities described herein, processor 331 generally configures the computer system and more particularly processing electronics 330 to complete such activities. Said another way, processor 331 is configured to execute computer code stored in memory 332 to complete and facilitate the activities described herein. Processing electronics 330 may include other hardware circuitry for supporting the execution of the computer code of memory 332.

Referring still to FIG. 3A, network communications module 112 is further shown to include logical camera ports 333. Logical camera ports 333 may be created by connection manager 304 when, for example, a camera is first connected to communication interfaces 202. For example, when a DHCP server element of connection manager 304 assigns a local IP address to the camera, it may be added to logical camera ports 333. In other embodiments, as multiple streams are requested for a single camera, a new logical port is created for the camera and the data duplicated across all of the camera's logical ports. Traffic manager 306 is further shown to include network address translation module 334. Network address translation module 334 is configured to map packets from the camera (e.g., logical port, communications interface associated with the camera, etc.) to another connected device (e.g., a remote client requesting video from the camera). Network address translation module 334 may use information stored in an address table 336 to conduct its activity. Network address translation module 334 can operate by modifying network address information of packet headers transmitted between the camera and a client. In another embodiment network address translation module 334 maps an address (e.g., logical port) for the camera to another address space or port using another suitable mapping method. Network address translation module 334 can be configured to hide the logical camera ports or address space for the cameras via its activity. For example, network address translation module 334 may be configured to modify and route packets so that communications to/from a public address or port are properly provided to/received from a private address or port. Address table 336 can store the forward as well as the reverse lookup information for the network address translation, which may be the same or different.

Referring further to FIG. 3A, traffic manager 306 is further shown to include web service 335. Web service 335 may be configured to expose the cameras or video services of networked device 110 to web requests. For example, web service 335 may be configured to receive a uniform resource identifier (URI) request for information from a service, camera, or location. Web service 335 may be configured to parse the URI request for a camera identifier and to cause network address translation module 334 to establish a port forwarding connection between the remote client and the camera (e.g., corresponding to the camera identifier, a logical port associated with the camera, a communications interface associated with the camera). Network communications module 112 is further shown to include a firewall 336. Network communications module 112 may further include yet other security modules or features.

Referring now to FIG. 3B, a flow chart of a process 340 for configuring the networked device and connected cameras is shown, according to an exemplary embodiment. Process 340 includes utilizing the connection manager to assign IP addresses (or other network variables) to a newly connected camera (step 341). The connection manager can then provide notice to a camera configuration module so that the camera configuration module begins its activity (step 342). The camera configuration module can then query the newly connected camera for detailed device information (step 343). When detailed device information is received from the newly connected camera, the information can be provided to one or more data stores. User configuration requests may be received at the user interface (step 344) and project data (e.g., tabulated project planning data) may be received from one or more data sources or interfaces (step 345). A configuration update service may be used to propagate configuration changes to cameras and/or to other stores of configuration data (step 346). Process 340 is further shown to include utilizing a QoS module to set (e.g., calculate, update, analyze, etc.) QoS parameters based on the camera configuration data, the detailed device information received from the cameras, project data stored in the system, uplink characteristics, and/or any other information (step 347).

Referring now to FIG. 3C, a system for providing digital video to a remote client from one of a plurality of cameras connected to networked device 110 is shown, according to an exemplary embodiment. Device 110 is shown to include a first set of communication interfaces 202, a second set of communication interfaces 204, and processing electronics 330 integrated with device 110 (e.g., housing of device 110). First set of communication interfaces 202 is configured to communicate with the plurality of video cameras and second set of communication interfaces 204 (e.g., the uplink interface) is configured to communicate with a remote client 339 for receiving the digital video. Processing electronics 330 are configured to respond to a URI request received at second set of communication interfaces 204 from the remote client 339 and to deliver the digital video to the remote client 339 by parsing the URI request for a camera identifier (e.g., “CameraA”). Processing electronics 330 may then establish a port forwarding connection between remote client 339 and the camera (e.g., the camera corresponding to the camera identifier, a logical port created in memory of the device, a particular port or other interface of the first set of communication interfaces, etc.). Processing electronics 330 are shown to include web service 335 which is configured to conduct the parsing of URI requests received from remote clients such as remote client 339. Processing electronics 330 further include network address translation module 334 configured to map packets for remote client 339 from the camera, logical port, or interface to appear to originate from, for example, the URI or an address associated with the URI.

In an exemplary embodiment the network address translation module 334 works in conjunction with or is a part of a network switch component 339 of networked device 110. In an exemplary embodiment processing electronics 330 are configured to expose a single IP address for the networked device 110 to the network via uplink interface 204. The networked device 110 uses the network address translation module 334 and the network switch 329 to provide video channels (e.g., DVR'd video, streaming video, etc.) from the cameras coupled to the communication interfaces 202 to clients 329 via the one IP address exposed at uplink interface 204. In other exemplary embodiments, more than one IP address may be exposed at uplink interface 204 (e.g., one for each video channel).

In other embodiments networked device 110 may include a digital video recorder module configured to store video from the plurality of cameras in memory and processing electronics 330 may be configured to use the logical port (e.g., logical port 333) to deliver the digital video to remote client 339 by providing digital video associated with the camera identifier from stored video in the memory to remote client 339. In further exemplary embodiments processing electronics 330 may include a QoS module configured to automatically adjust a QoS parameter for device 110 based on network characteristics such as the number of remote clients connected to second set of communications interfaces 204, capacity of networked device 110, capacity of the network between networked device 110 and remote client 339, or the content of the digital video communicated from the plurality of cameras to second set of communication interfaces 204.

Referring now to FIG. 3D, a process 350 for providing video from a plurality of cameras to a remote client is shown, according to an exemplary embodiment. Process 350 is shown to include connecting a first set of communication interfaces (e.g., interfaces 202 shown in FIG. 3C) to a plurality of digital video cameras (step 351). A logical port is assigned to each of the plurality of digital video cameras (step 352). The logical port may be assigned upon plugging in the camera, via a manual process, or upon the receipt of a request (e.g., URI request) at a second set of communications interfaces (e.g., uplink interface 204) from a remote client (step 353). Processing electronics integrated with the first and second sets of communications electronics are configured to parse the URI request for a camera identifier (step 354) and to establish a port forwarding connection between the remote client and the camera (step 355). The port forwarding connection may be provided between a public port for the remote client and the logical port already created for the camera, by creating a new logical port, by routing communications from a physical port to the port exposed to the remote client, or otherwise. The processing electronics then delivers the digital video to the remote client via the port forwarding connection (step 356). The processing electronics of the device may further be configured to analyze the content of the digital video communications provided via the port forwarding connection in view of network resources (step 357). The processing electronics may then adjust a QoS parameter for the network, a parameter for the camera, or for a digital video recorder integrated with the processing electronics based on the analysis (step 358). Additional detail regarding the analyzing and adjusting steps according to some exemplary embodiments is provided in FIGS. 4A and 4B.

Referring now to FIG. 4A, a process 400 for processing data received from a plurality of digital video cameras is shown, according to an exemplary embodiment. Process 400 is shown to include receiving compressed digital video from each of a plurality of cameras at a networked video recorder (step 402). Using the processing electronics of the digital video recorder, the compressed video is then stored (step 404) and analyzed (step 406). The results of the analysis may be an identification of a parameter indicative of complexity of the compressed digital video (step 408). Complexity may be calculated based on the number of moving blocks between frames, the percentage of moving blocks between frames, based on another indicator of movement, based on the size of the received video, based on a tag included with the compressed video or otherwise. A camera parameter (step 410) or a parameter of the digital video recorder (step 412) may be adjusted based on the complexity of the compressed video.

Referring now to FIG. 4B, a more detailed process 450 for processing compressed video from a plurality of digital video cameras is shown, according to an exemplary embodiment. Video frames of compressed video may be of different types depending on the particular compression algorithm used. Video compression is often achieved by interspersing partial frames between full frames of video information. For example, a frame type called a “p-frame” (which formally stands for “predicted picture frame”) includes only the changes in the image from the previous frame. A frame type called a “b-frame (“bi-predictive picture”) includes changes in the image relative to the previous frame as well as changes in a future image—which may be used to describe two frames worth of information while requiring much less than one frame of data. In other compression algorithms the granularity may be different. For example, in some compression algorithms a series of many p-frames or b-frames may exist between a fully specified picture (e.g., an i-frame). In yet other compression algorithms the frames themselves are broken into pieces and described separately (e.g., a recent international video compression standard known as H.264/MPEG-4 encodes different regions of pictures differently, resulting in I-slices, P-slices, and B-slices). Process 450 shown and described with reference to FIG. 4B uses the term “P-frame,” but it should be appreciated that various embodiments of the disclosure may analyze other “partial picture”-based compressed video.

Referring to process 450 shown in FIG. 4B, compressed video frames may be sequentially retrieved for analysis (step 452) per video channel. The video frames may be received from a camera and processed in a buffer in some embodiments. In other embodiments the video frames are stored in permanent memory by, e.g., a DVR process, and process 450 is a separate process that steps through the contents of the memory. Step 454 causes process 450 to wait until all of the packets for a frame are received (e.g., if the frame is full) before checking for whether the frame is a p-frame (or another partial image) (step 456). Process 450 then gets the p-frame size (“P_Size”) for the p-frame (step 458). The size may be embedded in the header for the frame, embedded within a packet of the frame data, determined by measuring the storage size of the p-frame with a separate process, determined by counting the number of changed blocks within the p-frame, or otherwise. In an exemplary embodiment the function for getting the size of the p-frame does not analyze the actual video information of the p-frame (e.g., count the number of changed blocks, etc.) or decompress the compressed video. In yet other exemplary embodiments the p-frame is transcoded and the content is analyzed (e.g., via a vector analysis of the movement from frame to frame, analyzed to obtain an amount or percentage of the frame being described in the p-frame, via an analysis of the significance of the movement, analyzed to determine whether the movement is noise or actual object movement, etc.).

In the exemplary embodiment shown in FIG. 4B, P_Size is pushed (or otherwise added) to an array (“P_Frame_Size”) (step 460). A median value from the P_Frame_Size array is calculated (step 462). The calculation to determine the median value may not include the entirety of the P_Frame_Size array in the calculation. Rather, the calculation might only examine a recent set of values in the array. The set of values used in the median calculation is also used to calculate a distribution of the values in the P_Frame_Size array (step 464). Process 450 further includes the step of determining whether the current frame's P_Size is above, below, or within a predetermined range (e.g., R standard deviations) of the median (step 466). When the current frame's P_Size is above the predetermined range of the median, processing electronics may analyze possible upward adjustments to video encoding parameters of the video for the channel (step 468). When the current frame's P_Size is below the predetermined range of the median, processing electronics may analyze possible downward adjustments to video encoding parameters of the video for the channel (step 472). When the current frame's P_Size is the range surrounding the median (e.g., within three standard deviations of the median), the processing electronics may hold the frame rate or quality of compression (step 470). As described above, settings may be adjusted at the camera level, at the digital video recorder level, or using other features of the above-described network device.

The predetermined range utilized by step 466 may be set by a user and held as a constant or may be adjusted by the system according to video or network conditions. For example, If the network is determined to be highly variable (e.g., many periods of low/high bandwidth switching), R may be reduced (e.g., to one or below) so that the processing electronics of the networked device analyze possible downward or upward adjustments (steps 468 and 472) more often.

In an exemplary embodiment the results of the analysis of possible upward adjustments to video encoding parameters include activities such as setting a higher frame rate (e.g., by providing a setting or command for a greater frame rate to the camera, by changing a frame rate setting at the video recorder, etc.) or setting a higher quality of compression (e.g., less compression). These setting changes may be caused to occur by providing a setting or command for higher quality of compression to the camera or by changing a compression setting of the video recorder if the compression occurs at the video recorder. Similarly, the results of the analysis of possible downward adjustments to video encoding parameters include activities such as setting a lower frame rate (e.g., by providing a setting or command for a lower frame rate to the camera, by changing a frame rate setting at the video recorder, etc.) or setting a lower quality of compression (e.g., more compression, decreasing the number of p-frames relative to the number of i-frames, etc.). These settings changes may be caused to occur by providing a setting or command for lower quality of compression to the camera or by changing a compression setting of the video recorder.

Referring now to FIG. 4C, an exemplary embodiment of a possible analysis of steps 468 and 472 from FIG. 4B is shown in the form of a flow diagram for a process 480. Process 480 is shown to begin with getting the total network bandwidth available in the network switch or to the network switch (step 482). The total network bandwidth available may be based on an instantaneous calculation, a smoothed calculation, a minimum available ninety percent of the time, network characteristics, switch characteristics, a setting stored in memory of the network device, or otherwise. Process 480 further includes examining P_Frame_Size trends per channel to predict future channel needs (step 484) (e.g., in terms of bandwidth). Process 480 further includes determining the number of active channels and dividing the total bandwidth available (e.g. obtained in step 482) by the number of active channels (step 486). The available bandwidth (e.g., bandwidth headroom) is then determined across all channels (step 488) and distributed across the channels based on the channel trends (step 490). A result of or a step of distributing available bandwidth across the channels may be or include selecting a capture or encoding parameter set given the determined available bandwidth to distribute to the channel (step 492). FIG. 4C illustrates one possible selection scheme for step 492. A table or other information structure of the possible capture/encoding settings may be stored in memory of the networked device (illustration in upper left hand corner of FIG. 4C). Using the information in the table, a bandwidth requirement may be calculated for all possible setting combinations. The resultant bandwidth requirements may be reverse (or otherwise) sorted in terms of throughput and a process may make a selection given the bandwidth available to distribute to the channel. For example, if the process predicts that channel “A” will need more bandwidth in the future, a selection process may determine that channel “A” can be given up to 10 Mbps worth of bandwidth and use the sorted list to “select” an encoding combination associated with 10 Mbps worth of throughput. As is illustrated in FIG. 4C, the combination may comprise some settings that are generally referred to as “high” quality settings and some other settings that may be considered medium or low quality settings. For example, a 10 Mbps selection may correspond with an HDI resolution, a 15% quantization level, and a group-of-pictures or i-frame insertion period of 17 frames per second. The selection process may utilize a weighting function or another function to determine which of multiple “trending upward” channels to distribute the available bandwidth. This determination may include, for example, determining how much of each frame (e.g., p-frame) includes motion and determining “floor” bandwidth targets based on the motion. For example, if more than twenty percent of a p-frame experiences motion and that number is trending upward, the system may determine not to allow a selection of under 3 Mbps for that channel. Accordingly, a present invention will advantageously allocate available bandwidth to those channels that are the most complex (e.g., experiencing the most motion) and decrease the bandwidth expenditure (e.g., select down) those channels that are not capturing complex video. The selection step may end in providing new settings to cameras, providing new settings to network switching circuitry of the networked device, providing new settings to a digital video recorder, providing new settings to a streaming module of the networked device, etc.

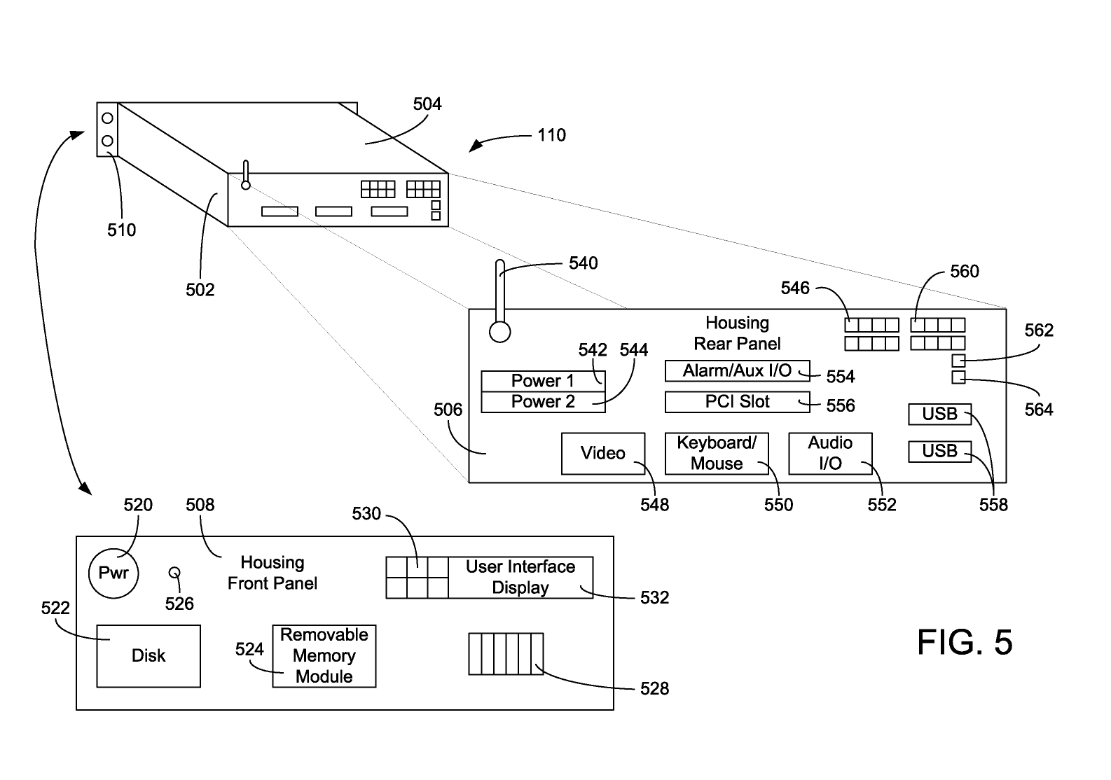

Referring now to FIG. 5, networked device 110, and particularly networked device 110's housing (e.g., device housing 212 of FIG. 2), is shown in greater detail, according to an exemplary embodiment. According to an exemplary embodiment, the housing is generally shaped as a rectangular box (e.g., cuboid, rectangular prism, etc.) but may be shaped differently according to other exemplary embodiments. In the embodiment shown in FIG. 5, housing side panels 502 cover each side of networked device 110, a housing top panel 504 covers the top of networked device 110, a housing rear panel 506 covers the rear of networked device 110 and contains a number of functional elements, and a housing front panel 508 covers the front of networked device 110 and contains additional functional elements. In some exemplary embodiments networked device 110 may be rack-mounted (e.g., using rack-mount brackets 510). In yet other exemplary embodiments networked device 110 does not include rack-mount brackets. Some embodiments of networked device 110 may be configured for vertical installation in a device array or rack while other embodiments of networked device 110 (e.g., the embodiment shown in FIG. 5) are configured for horizontal installation in a device array or rack. Further, while the embodiment illustrated in FIG. 5 includes panels covering each of the six sides of networked device 110, it should be noted that in some exemplary embodiments some of the panels may be removed (e.g., top panel 504) or not present; in these cases the video module and the network communications module of networked device 110 may still be considered to be housed within the housing of networked device 110 when within the boundaries of the shape formed by structures (e.g., rails, frame elements, etc.) of networked device 110.

Front panel 508 of networked device 110 is shown to include a power button (“Pwr”) 520, a slot 522 for adding or removing a hard disk drive, a removable memory module 524, one or more indicator lights 526 (e.g., LEDs), one or more external storage interfaces 528 (e.g., USB, iSCSI, firewire), UI elements 530 (e.g., buttons), and a user interface display 532 (e.g., an LCD display, an OLED display, etc.). UI elements 530 and user interface display 532 may be used to display configuration data (e.g., quality of service data, policy data, camera data, configuration data, etc.) or to allow the user input of configuration data. For example, if the user would like to allocate a limited amount of bandwidth for the plurality of cameras and networked device 110 on the network, the user may be able to enter an “available bandwidth,” “target bandwidth” or “maximum bandwidth” parameter for the networked device. Networked device 110 may store these parameters for use in adjusting other parameters of networked device 110, for one or more the cameras, or otherwise. For example, networked device 110 may utilize the parameter inputs at user interface display 532 or UI elements 530 in processes for adjusting the compression of the video, a camera parameter, a digital video recorder parameter, or otherwise.

Rear panel 506 of networked device 110 is shown to include an RF antenna 540, multiple power indicators 542, 544, ports 546 for receiving power cables, a video output port 548, a keyboard/mouse port 550, an audio input/output (I/O) port 552, an alarm/auxiliary I/O port 554, a PCI slot 556, and USB ports 558. Rear panel 506 is further shown to include communication ports 560 (e.g., Ethernet ports for connecting the cameras and other networked devices), and one or more uplink ports 562, 564. RF antenna 540 can be used by a wireless transceiver in networked device 110 to connect wireless cameras or other wireless devices to networked device 110. The same DHCP services, configuration services, and QoS management services can be provided to cameras connected to networked device 110 wirelessly.

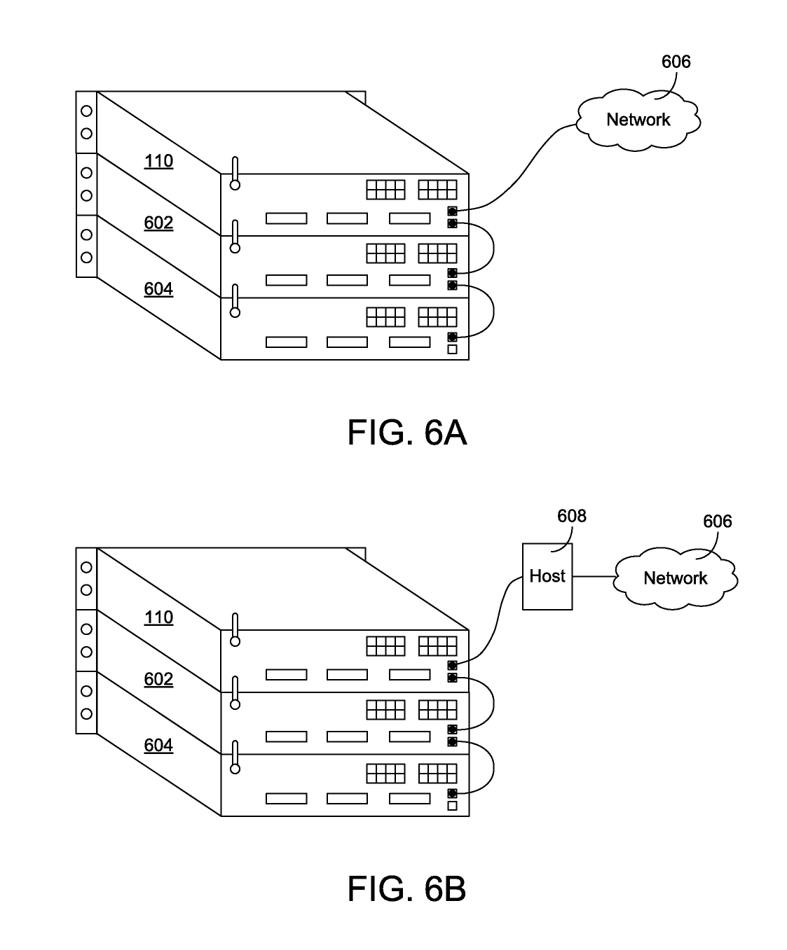

Referring now to FIGS. 6A and 6B, networked device 110 may be configured for linking (e.g., daisy-chaining) to another networked device or devices 602, 604 so that the camera network can be expanded. In such a configuration, the QoS manager of one of the networked devices (e.g., networked device 110) is configured to serve as a master while the QoS managers of the other networked devices (e.g., networked devices 602, 604) may serve as slave devices. This master-slave decision may occur by only one master “token” being available to a plurality of connected devices 110, 602, 604. Accordingly, the master QoS manager can be configured to help distribute the limited resources of network 606 to various networked devices 110, 602, 604 and the connected cameras. In FIG. 6B, a host 608 may exist between networked devices 110, 602, 604 and network 606 to manage array of networked devices 110, 602, 604. Either the master networked device of FIG. 6A or host 608 of FIG. 6B can be configured to adjust the frame rate, compression, or other video settings for a plurality of connected video cameras based on the total available bandwidth on network 606 or on other network, client, or system conditions.

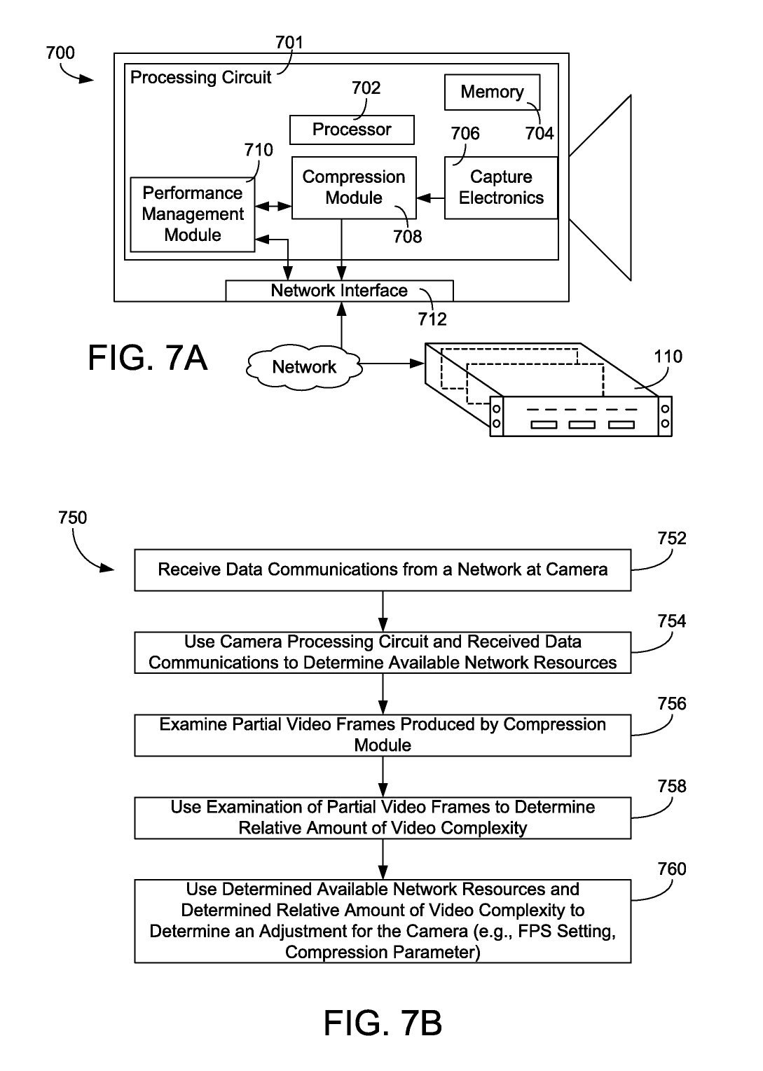

Referring now to FIG. 7A, a block diagram of a camera 700 configured to provide compressed video over a network and to adjust itself using, for example, the processes of FIGS. 4B and 4C is shown, according to an exemplary embodiment. Camera 700 is shown to include a processing circuit 701. Processing circuit 701 is configured to determine available network resources for transmitting compressed video. Processing circuit 701 is further configured to adjust a parameter (e.g., frames per second, a compression parameter, etc.) based on the determined available network resources. In an exemplary embodiment, camera 700 is configured to receive information describing the available network resources from a remote source (e.g., networked device 110).

Referring further to FIG. 7A, processing circuit 701 is shown to include a processor 702 and memory 704. Processor 702 may be a general purpose or specific purpose processor configured to execute computer code or instructions stored in memory 704 or received from other computer readable media (e.g., CDROM, network storage, a remove server, etc.). Memory 704 may be RAM, hard drive storage, temporary storage, non-volatile memory, flash memory, optical memory, or any other suitable memory for storing software objects and/or computer instructions. When processor 702 executes instructions stored in memory 704 for completing the various activities described herein, processor 702 generally configures the computer system and more particularly processing circuit 701 to complete such activities. Said another way, processor 702 is configured to execute computer code stored in memory 704 to complete and facilitate the activities described herein. Processing circuit 701 may include other hardware circuitry for supporting the execution of the computer code of memory 704 or of modules 710 or 708.

Capture electronics 706 are configured to capture analog or digital video and to provide the captured video to compression module 708. Compression module 708 is configured to compress the video received from capture electronics 706. Compression module 708 provides the compressed video to network interface 712 for transmission to a network or a remote source (e.g., networked device 110 for recording or redistribution). Performance management module 710 may receive information regarding the compression (e.g., information regarding the changing p-frame size of the compressed video) from compression module 708. Performance management module 710 may be configured to operate as described with reference to FIGS. 4A and 4B and to provide feedback to compression module 708 in the form of new encoding settings, new frame per second settings, or otherwise. In an exemplary embodiment, performance management module 710 is also configured to determine available network resources for transmitting the compressed video using, for example, information about network performance from network interface 712 or information from networked device 110. Performance management module 710 may adjust a parameter of compression module 708 based on the determined available network resources. In an exemplary embodiment, performance management module 710 is configured to examine the compressed video (e.g., p-frame size, b-frame size) produced by compression module 708 of camera 700 and to determine whether the activity level or complexity of the compressed video has significantly changed. This determination may be based, for example, on whether the p-frame size and/or b-frame size has significantly increased. Performance management module 710 may be configured to determine that the p-frame size or b-frame size have significantly changed when the p-frame size or b-frame size are above or below the median size by a predetermined amount (e.g., one standard deviation, three standard deviations, etc.).

Referring now to FIG. 7B, a flow chart of a process 750 for providing compressed video over a network from a camera such as camera 700 of FIG. 7A is shown, according to an exemplary embodiment. Process 750 is shown to include receiving data communications from a network at the camera (step 752) and using the received data to determine available network resources (step 754). A processing circuit of the camera is configured to examine partial video frames produced by a compression module of the camera (step 756). Other analysis steps may be conducted on the compressed video to, for example, judge the activity level or motion level of the scenes captured by the compressed video. The examination of the partial video frames is used to determine a relative amount of video complexity (step 758) of recent, current, or predicted video. Process 750 further includes using the determined available network resources and the determined relative amount of video complexity to determine an adjustment for the camera (e.g., FPS setting, compression parameter, etc.) (step 760).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure. Further, it should be noted that various alternative embodiments of the above mentioned networked device may be applied to information other data types and systems. For example, the networked device may be used to obtain information from a network of microphones or other audio providing devices, a network of temperature sensors, or any other network of devices that may provide information to a central networked device for further dissemination or recording.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. It should be understood that the present application is not limited to the details or methodology set forth in the description or illustrated in the figures. It should also be understood that the terminology is for the purpose of description only and should not be regarded as limiting.

What is claimed is:

1. A device for providing digital video to a remote client from one of a plurality of video cameras connected to the device, the device comprising:
a housing;
a first set of communication interfaces, a second set of communication interfaces, and processing electronics integrated with the housing;
wherein the first set of communication interfaces is configured to communicate with the plurality of video cameras;
wherein the second set of communication interfaces is configured to communicate with a remote client for receiving the digital video;
wherein the processing electronics are configured to respond to a uniform resource identifier (URI) request received at the second set of communication interfaces from the remote client and to deliver the digital video to the remote client by parsing the URI request for a camera identifier and establishing a port forwarding connection between the remote client and at least one of: (a) a camera corresponding to the camera identifier, (b) a logical port created in memory of the device, and (c) an interface of the first set of communication interfaces.

2. The device of claim 1, wherein the processing electronics further comprise a web service configured to conduct the parsing of URI requests received from remote clients.

3. The device of claim 1, wherein the processing electronics further comprise a network address translation module configured to map packets for the remote client to appear to originate from at least one of the URI and an address associated with the URI.

4. The device of claim 1, further comprising:
a digital video recorder module configured to store video from at least one of the plurality of cameras in memory.

5. The device of claim 4, wherein the logical port used in the delivery of the digital video to the remote camera provides digital video associated with the camera identifier from stored video in the memory.

6. The device of claim 1, further comprising:
a quality of service manager configured to automatically adjust at least one quality of service parameter for the device based on the number of remote clients connected to the second set of communications interfaces.

7. The device of claim 1, further comprising:
a quality of service manager configured to automatically determine and provide new camera settings to the plurality of cameras based on capacity of at least one of the device and network coupled to the second set of communication interfaces.

8. The device of claim 1, further comprising:
a quality of service manager configured to automatically adjust at least one quality of service parameter for the device, the plurality of cameras, or a digital video recorder integrated with the device based on the content of the digital video communicated from the plurality of cameras to the second set of communication interfaces.

9. The device of claim 1, wherein the first set of communications interfaces comprise at least one of Ethernet ports and wireless communications electronics; and wherein the second set of communication interfaces includes a single Ethernet uplink.

10. A device for recording digital video from a plurality of cameras connected to the device, the device comprising:
a communication interface configured to receive compressed digital video from each of the plurality of cameras; and
processing electronics including a digital video recorder module configured to store the compressed digital video;
wherein the processing electronics are further configured to identify a parameter indicative of complexity of the compressed digital video from each of the plurality of cameras;
wherein the processing electronics are further configured to adjust at least one of a camera parameter and a parameter of the digital video recorder module based on the parameter indicative of the complexity of the compressed digital video.

11. The device of claim 10, wherein the processing electronics are further configured to compare the relative video complexity between a plurality of video cameras using the identified parameters.

12. The device of claim 11, wherein the processing electronics are further configured to adjust the camera parameter or the parameter of the digital video recorder module based on the relative video complexity and information regarding available network resources.

13. The device of claim 10, wherein identifying a parameter indicative of the complexity of the compressed digital video comprises identifying whether at least one of a p-frame size and a b-frame size have significantly changed.

14. The device of claim 10, wherein the at least one of a camera parameter and a parameter of the digital video recorder module comprises a frames per second setting or compression quality.

15. The device of claim 10, further comprising a housing configured to integrate the communication interface for the plurality of the cameras and the processing electronics including the digital video recorder module with a network management module.

16. The device of claim 10, wherein the processing electronics are configured to use network address translation to isolate the plurality of video cameras from at least one of ports, addresses, or interfaces available to client devices receiving the compressed digital video.

17. A camera configured to provide compressed video over a network, the camera comprising:
a processing circuit configured to determine available network resources for transmitting the compressed video; wherein the processing circuit is further configured to adjust at least one of a frames per second setting for the camera and a compression parameter for the compressed video based on the determined available network resources.

18. The camera of claim 17, wherein the camera is configured to receive information describing the available network resources from a remote source.

19. The camera of claim 17, wherein the processing circuit is further configured to examine at least one of a p-frame size and a b-frame size of the compressed video produced by a compression module of the camera and to determine whether the p-frame size and/or b-frame size have significantly changed;
wherein the processing circuit is further configured to adjust the at least one of the frames per second setting for the camera and the compression parameter for the compressed video based on the determination of whether the p-frame size and/or b-frame size have significantly changed.

20. The camera of claim 19, wherein the processing circuit is configured to determine that the p-frame size and/or b-frame size have significantly changed when the p-frame size and/or b-frame size are above or below three standard deviations of the median size.
